(19) United States
(12) Patent Application Publication
(10) Pub. No.: US 2025/0123350 A1
(43) Pub. Date: Apr. 17, 2025

(54) SUBARRAY ANGLE OF ARRIVAL PROCESSING FOR NEAR FIELD EFFECTS REDUCTION

(71) Applicant: MOBILEYE VISION TECHNOLOGIES LTD., Jerusalem (IL)

(72) Inventors: Ilia YOFFE, Hod-HaSharon (IL); Lidor DAHAN, Sderot (IL); Alon COHEN, Modiin Macabim Reut (IL)

(73) Assignee: MOBILEYE VISION TECHNOLOGIES LTD., Jerusalem (IL)

(21) Appl. No.: 18/915,051

(22) Filed: Oct. 14, 2024

Related U.S. Application Data
(60) Provisional application No. 63/590,661, filed on Oct. 16, 2023.

(51) Int. Cl. G01S 3/14; G01S 3/74; G01S 7/41

(52) U.S. Cl. CPC G01S 3/143; G01S 3/74; G01S 7/41

(57) ABSTRACT

A method, a sensor system, and a non-transitory computer readable medium are provided. Embodiments comprise receiving a plurality of incident signals reflected from a target at a plurality of receiver antennas. A processor identifies a subset of receiver antennas from the plurality of receiver antennas and performs angle of arrival (AOA) processing on respective incident signals of the subset of receiver antennas. The processor determines an angle of arrival of the target based on the AOA processing.

### CROSS-REFERENCE TO RELATED APPLICATIONS

This application claims priority to U.S. Provisional Application No. 63/590,661, filed Oct. 16, 2023, which is hereby incorporated by reference in its entirety.

### FIELD

The field relates to radar devices, for example, angle of arrival processing in a near field.

### BACKGROUND

Autonomous vehicles, vehicles that include advanced driver assistance systems (ADAS), and robotic devices rely on data from sensors, cameras, radars, and lidars to perceive a real-world environment during operation. The data are processed to detect one or more objects in the real-world environment.

In general, a transmit antenna of a radar radiates a radio frequency (RF) signal that propagates toward an object in a field of view of the radar. Signals reflected by the object depend on a backscatter property (i.e., Radar Cross Section) of the object. The signals reflected by the object are received by a receiving antenna of the radar. Typically, the receiving antenna is connected to a processing device. The processing device processes the signals reflected by the object to determine a position of the object (e.g., elevation). In some scenarios (e.g., at very close range of the object), the processing can pose some challenges, such as inaccuracy. Moreover, advanced processing methods for such scenarios suffer from high computational complexity.

Improved methods for processing radar data are needed.

### SUMMARY

According to an embodiment, a method for determining an angle of arrival of a target is provided. In the method, a plurality of incident signals reflected from the target are received at a plurality of receiver antennas. A processor identifies a subset of receiver antennas from the plurality of receiver antennas and performs angle of arrival (AOA) processing on respective incident signals of the subset of receiver antennas. The processor determines an angle of arrival based on the AOA processing.

According to an embodiment, a sensor system comprises a plurality of receiver antennas and a processor coupled to the plurality of receiver antennas. The processor is configured to identify a subset of receiver antennas from the plurality of receiver antennas, perform AOA processing on respective incident signals of the subset of receiver antennas. The processor is also configured to determine an angle of arrival based on the AOA processing.

System, device, and computer program product aspects are also disclosed.

Further features and advantages, as well as the structure and operation of various aspects, are described in detail below with reference to the accompanying drawings. It is noted that the specific aspects described herein are not intended to be limiting. Such aspects are presented herein for illustrative purposes only. Additional aspects will be apparent to persons skilled in the relevant art(s) based on the teachings contained herein.

### DESCRIPTION OF DIAGRAMS

The features and advantages of the example embodiments described herein will become apparent to those skilled in the art to which this disclosure relates upon reading the following description, with reference to the accompanying drawings.

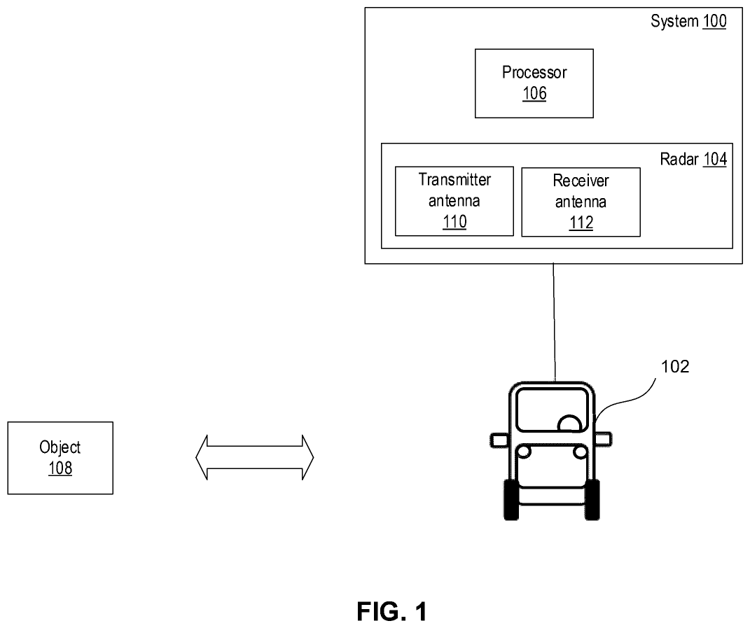

FIG. 1 illustrates a block diagram of a system including a radar, according to some embodiments.

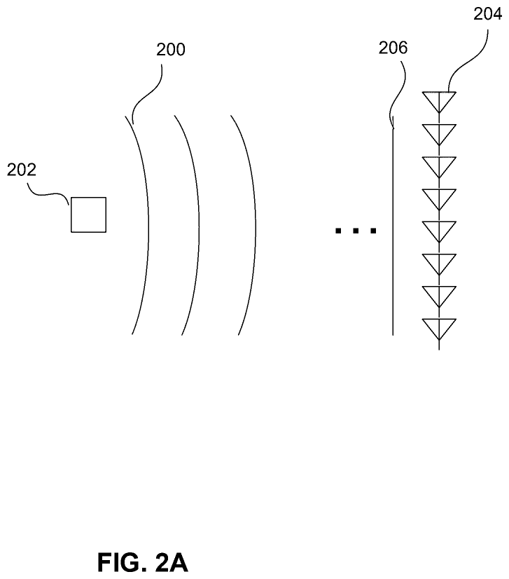

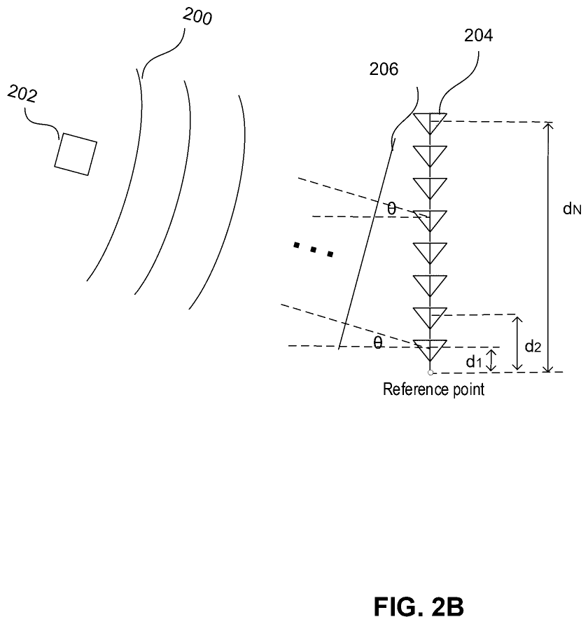

FIG. 2A illustrates reflected waves from a target located in the far field of a radar, according to some embodiments.

FIG. 2B illustrates reflected waves from a target located in the far field of a radar incident at an angle with respect to a receiving array of the radar, according to some embodiments.

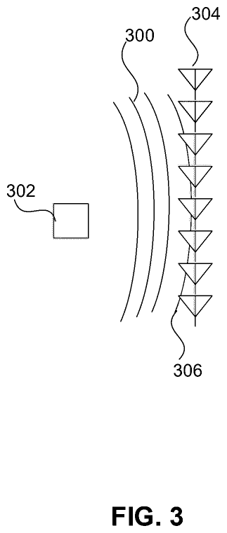

FIG. 3 illustrates reflected waves from a target located in the near field of a radar, according to some embodiments.

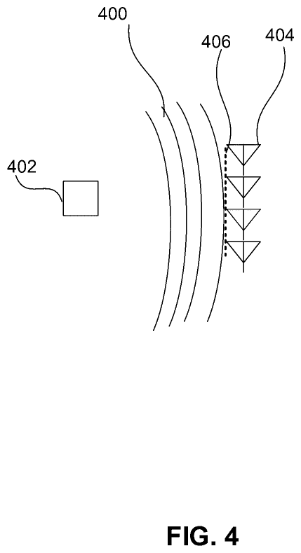

FIG. 4 illustrates reflected waves from a target located in the near field of a radar received at a subarray of an antenna, according to some embodiments.

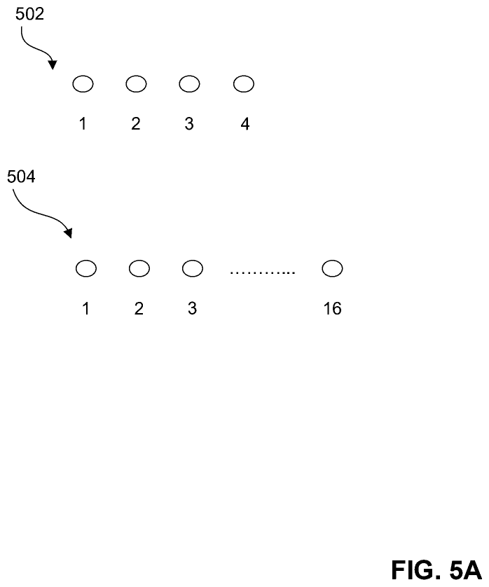

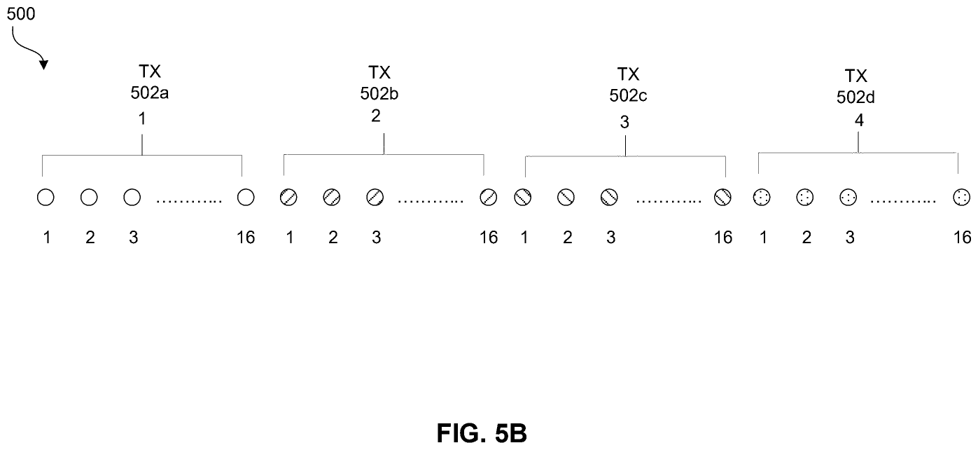

FIG. 5A illustrates a transmitter array and a receiver array of a multiple input multiple output (MIMO) antenna array, according to some embodiments.

FIG. 5B illustrates a uniform linear array for a MIMO antenna array, according to some embodiments.

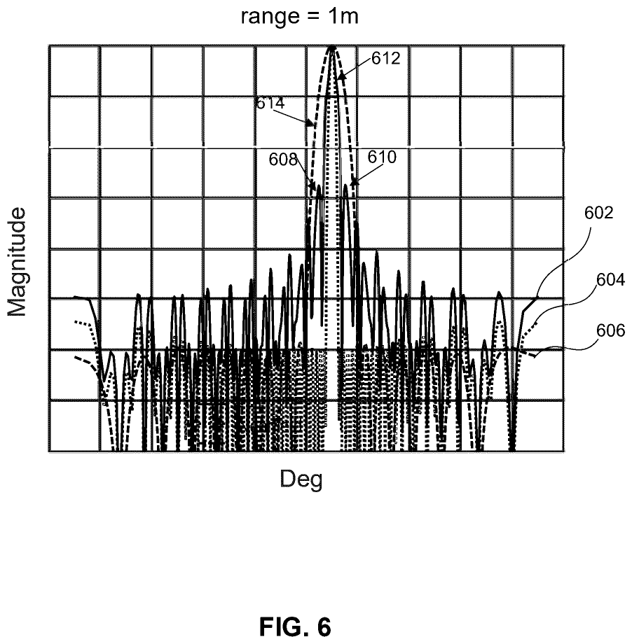

FIG. 6 illustrates angle of arrival spectrums generated using different processing techniques, according to some embodiments.

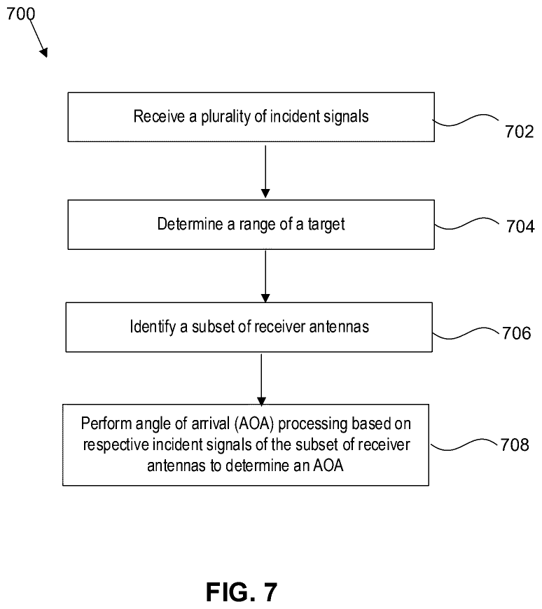

FIG. 7 is a method for determining an angle of arrival of a target, according to some embodiments.

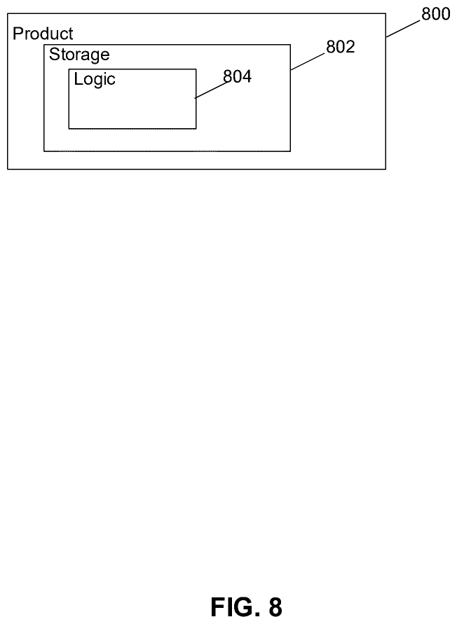

FIG. 8 shows an embedded system, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

A radar is a sensor that identifies objects in a four dimensional (4D) space. The radar may identify a range (distance), an azimuth (AZ) (direction), a relative velocity (Doppler), and an elevation (EL) of an object in an environment. The radar may radiate a beam of electromagnetic energy from a transmitter antenna of the radar. When an object (e.g., a target, a road agent, a pedestrian, a pavement, a post, a vehicle, a cyclist) is illuminated by the beam, the object reflects a portion of the radiated energy back toward a receiver antenna of the radar. By processing the reflected energy received at the receiver antenna, the radar may compares the transmitted and received signals to determine the 4D spatial information of the object (e.g., the 3D position and the radial velocity information).

The azimuth and elevation are determined using angle of arrival (AOA) algorithms based on the received signals. In particular a radar system may include a plurality of transmitters and a plurality of receivers. Positional information of a target can be determined using a plurality of incident signals reflected from the target and received at the plurality of receivers. Radar reflections behave and are modeled as a point source. Incident radar waves induce currents in conductive materials. The currents behave like a radiating antenna. The point source radiates in a spherical (or part of) wave front. The radius of the sphere is the distance between a reflective object and the receiver antenna of the radar. Hence, when the object is far away (i.e., in the far field zone), the error from simplifying the physical model to be a plane wave front is small and can be neglected. However, for close objects (i.e., in the near field zone), the errors from such a simplification are considerable and should be accounted for. For targets located in the far field of the sensor system, AOA algorithms may use plane wave AOA algorithms (e.g., Fast Fourier Transform (FFT) processing) to determine a spatial frequency of the plurality of incident signals. However, for targets located in the near field of the sensor system, the plurality of incident signals cannot be simplified as plane waves. Thus, for near-field signals, AOA processing conventionally uses matched filtering techniques. However, matched filtering techniques have a high computational cost.

Aspects of the invention use data from a subset of the plurality of receivers in the AOA processing for targets located in the near field of the sensor system. When only the subset of receivers are used, the returning signal, which may appear spherical when all the receivers used, instead appears planar. Because the plurality of incident signals can be considered plane waves, plane waves AOA algorithms (e.g., FFT processing) may be used. In this way, near field effects can be reduced.

In addition, spectrum from multiple subsets of receiver antennas may be combined coherently or non-coherently to provide enhanced target tracking, e.g., high signal-to-noise (SNR) ratio. In some embodiments, the sensor system comprises a multiple input multiple output (MIMO) radar and the subset of the plurality of receivers corresponds to a subarray of the virtual array of the MIMO radar.

FIG. 1 illustrates a block diagram of a system 100 including a radar 104, according to some embodiments. A vehicle 102 may be configured to support system 100 (e.g., to be mounted or implemented in vehicle 102). Vehicle 102 includes a car, a truck, a motorcycle, a bus, a motorcycle, a ship, or any other vehicle. System 100 may include an autonomous vehicle system, an automated driving system, a driver assistance system, an advanced driver assistance system, or the like.

ADAS, or advanced driver assistance systems, are technologies that enhance the safety and convenience of drivers and passengers by providing assistance, warnings, or interventions in various driving scenarios. ADAS can involve parking sensors, blind spot monitors, adaptive cruise control and lane keeping assist, to fully autonomous ones, such as self-parking and self-driving. ADAS can help reduce human error, improve traffic flow, lower fuel consumption, and prevent collisions and injuries.

Autonomous vehicles, also known as self-driving cars, are vehicles that can operate without human intervention or supervision, using sensors, cameras, software, and artificial intelligence to perceive and navigate their environment. Autonomous vehicles have the potential to improve road safety, mobility, efficiency, and environmental sustainability, by reducing human errors, traffic congestion, fuel consumption, and greenhouse gas emissions.

System 100 may receive input from a plurality of sensors. Based on the input, system 100 may detect and determine one or more characteristics (e.g., a size, a velocity, a location, a class) of an object 108 in the environment of vehicle 102. Using the one or more characteristics, system 100 may control a behavior of vehicle 102 (e.g., path planning, steering, braking, and the like). The plurality of sensors may include a light detection and ranging sensor (lidar) sensor, a camera sensor, a radar, and the like.

Vehicle 102 may include radar 104. Radar 104 may comprise one or more radars of the same type or different radar types. Radar 104 may be installed in vehicle 102 (e.g., mounted on a surface of vehicle 102 or inside vehicle 102) for detecting one or more objects (targets).

Radar 104 may include a transmitter antenna (Tx) 110 and a receiver antenna (Rx) 112. Transmitter antenna (Tx) 110 may include a plurality of antenna elements and receiver antenna (Rx) may include a plurality of antenna elements 112. In some embodiments, radar 104 may include a plurality of antenna elements arranged in both a vertical direction and a horizontal direction in order to provide elevation information. In some embodiments, radar 104 may include a MIMO radar.

MIMO radars may include multiple transmitting (Tx) and receiving (Rx) elements with a separability feature between the Tx elements. The Tx side transmits orthogonal waveforms, while the Rx side uses this orthogonality and information on the location of Tx antennas to build a virtual array. The virtual array has a larger aperture than the original Rx array and as a result, improves the performance of the AOA processing. For example, In the receiver side, signal processing methods can work on Tx-Rx pairs with minimum self-interference.

MIMO radar systems transmit different signals from multiple transmit antennas to extend resolution. The different signals multiple from different transmit antennas are extracted from each of the receive antennas. In this way, by varying the signals, the physical array can be virtual extended. For example, if a MIMO radar system has 3 transmit antennas and 4 receive antennas, 12 signals can be extracted from the receiver because of the orthogonality of the transmitted signals. That is, a 12-element virtual antenna array is created using only 7 antennas, thereby obtaining a finer spatial resolution compared with its phased array counterpart.

As discussed above, radar 104 may radiate a beam of electromagnetic energy via transmitter antenna (Tx). For example, the plurality of antenna elements may transmit a waveform having a frequency in a radio frequency (RF) band. The RF band may have a starting frequency above 10 Gigahertz (GHz), for example, a frequency band having a starting frequency between 10 GHz and 120 GHz, between 30 GHz and 100 GHz, or between 100 GHz and 300 GHz. In some embodiments, the RF band may correspond to an automotive radar frequency band (i.e., a band between 76 GHz to 81 GHz).

Waveforms radiated by transmitter antenna (Tx) propagate through the environment and encounter object 108. A portion of the waveforms may be reflected by object 108 and are received by the receiver antenna (Rx).

After receiving the reflected waveforms, system 100 may process the reflected waveforms. Radar 104 may be coupled to a processor 106. Processor 106 may be configured to generate radar information based on radar signals communicated by radar 104. Radar information may include range information, Doppler information, and/or Angle of Arrival information. In some aspects, the radar information may be used to generate the four dimensional (4D) image information corresponding to object 108. The 4D image information may include a range value based on the range information, a velocity value based on the Doppler information, an azimuth value based on azimuth AOA information, an elevation value based on elevation AoA information.

To generate the 4D image information, processor 106 may process the reflected waveforms. Processor 106 may include a baseband processing unit (BPU). The BPU may determine the range of object 108 based on the power of the reflected waveforms. Further, the BPU may determine the velocity of object 108 based on the Doppler effect. AZ and EL estimation are performed using angle of arrival (AOA) algorithms. An input of the AOA algorithm is spatial channels of each antenna element of the receiver antenna (array signals). An output of the AOA algorithm is a spatial spectrum indicative of the AZ and EL of object 108. For example, processor 106 may identify a peak in the spatial spectrum. The azimuth of object 108 may correspond to the location of the peak (i.e., x-coordinate). As described further below, AOA algorithm may implement a Fast Fourier Transform (FFT) process or other AOA algorithms (e.g., super resolution such as multiple signal classification (MUSIC), compressed sensing) to obtain the spatial spectrum for objects located in the far field of the radar. For objects located in the near field, the AOA algorithm may use a subarray of the receiving antenna (Rx) to implement the FFT process. The AOA process is further described in relation with FIG. 7. In some aspects, a joint process (e.g., joint estimation) may be applied to determine two or more dimensions of the 4D spatial information of the object (e.g., azimuth and Doppler).

After estimating the azimuth and elevation of object 108, processor 106 may generate radar point cloud data and track one or more objects in the environment of vehicle 102.

Using one or more subarrays of the antenna (e.g., subarray of a virtual MIMO array) during AOA processing provides a technical advantage of reducing the computational complexity for determining radar data for an object located in the near field.

In some embodiments, system 100 may be implemented in a robotic device or a drone.

FIG. 2A illustrates reflected waves 200 from a target 202 located in the far field of a radar (e.g., radar 104 of vehicle 102), according to some embodiments. Reflected waves 200 may emanate from target 202 spherically toward a receiving array 204 of the radar. While reflected waves, due to the distance of the far field target 200, by the time reflected waves 200 reach the receiving array 204, they appear as a plane wave 206. Reflected waves 200 are received by a receiving array 204. By assessing the relative time of arrival of the plane wave, a system can determine the AOA. FFT may be used to asses the time of arrival and determined the AOA as described below.

FIG. 2B illustrates reflected waves 200 from a target 202 located in the far field of a radar (e.g., radar 104 of vehicle 102) incident at an angle θ with respect to receiving array 204 of the radar according to some embodiments. As described above, reflected waves 200 may emanate from target 202 spherically toward a receiving array 204 of the radar. While reflected waves 200 are emitted spherically, due to the distance of the far field target 200, by the time reflected waves 200 reach the receiving array 204, they appear as a plane wave 206. The received signal at each element of receiving array 204 is proportional to exp (−j2πd_{n/λ} sin(θ)) where dₙ represents a distance between a reference point to the element of the receiving array and λ is the wavelength of the reflected waves. For a uniform array (i.e., equal spacing between each element of the array (d₁)), a phase difference between two signals received at two elements is proportional to 2πd_{1/λ} sin(θ) or a path difference of d₁ sin(θ). Each element of the antenna array receive the same but delay signal with respect to another element. The linear phase leads to a single spatial frequency (the spatial frequency may be obtained be taking the derivative of the phase, for a linear phase ax+b the spatial frequency will be a).

Due to the single spatial frequency of the reflected waves 200, AOA processing may use a FFT process. The FFT process may be used to obtain the spatial frequency spectrum in order to obtain the angle of arrival. One advantage of FFT is a low computational complexity. Thus, azimuth and elevation information for objects located in the far field of the radar may be estimated accurately with a low computational cost.

FIG. 3 illustrates reflected waves 300 from a target 302 located in the near field of the radar, according to some embodiments. In the near field, reflected waves 300 are spherical waves 306 (as opposed to plane waves 206 for reflected waves 200).

Because we cannot assume the waves are planer in the near field, an assumption needed to use FFT does not hold. Instead of FFT, to conduct AOA estimation for spherical waves, matched filtering implemented by matrix multiplication can be used. Using the matched filtering techniques, reflected waves are compared to previously measured intensities for different azimuth angles (e.g., 0 degree, 30 degree). Based on the comparison, a best match is identified. The azimuth of target 202 may correspond to the best match. The matching is done for each hypothesis which renders the AOA processing computational complex for target located in the near field. While matched filtering enables AOA determination in the near field, it has a higher computational complexity than the FFT process.

As discussed above the 4D image information may depend on a cross-range of the radar. The cross-range resolution of the radar depends on both range and angular resolution of system 100). Assuming a fixed cross range system requirement in meter for short and long ranges, for close ranges (e.g., near field), the angular resolution requirements of system 100 can be relaxed. This may be true in the context of autonomous vehicles and advanced driver assistance because when the objects are close enough to appear in the near field, the vehicle may need to steer far clear of them anyway. If the angular near filed resolution requirement is relaxed, a subarray of the receiver antenna (Rx) of radar 104 of system 100 may be used in the AOA processing. A subarrary of the receiver antenna (Rx) is an array that includes a portion of the antenna elements of the receiver antenna (Rx). For example, if the receiver antenna (Rx) comprises 10 elements, the subarray may use 5 elements. Using only a partial array may have effect of reducing resolution. However, when only a partial array of receivers positioned near one other are used, an otherwise spherical wave may appear planar. This is illustrated in FIG. 4.

The subarray is selected such as to obtain a reduced aperture size. For a smaller aperture, the spherical waves may be approximated as plane waves as shown in FIG. 4. Thus, processor 106 may use a FFT based processing or other plane wave AOA processing technique to determine the radar information. Using the low complexity FFT based processing provides the advantage of having a lower computational complexity and a smaller chip. In addition, the power consumption is reduced.

FIG. 4 illustrates reflected waves 400 from a target 402 located in the near field of the radar, according to some embodiments. Reflected waves 400 are received by a subarray 404 of the array of the receiver antenna (Rx) of system 100 (as shown subarray 404 comprises a portion of the elements of array 304). Although, reflected waves 400 are spherical waves they may be considered plane waves 406 with respect to a subset of antenna elements (subarray of an array of the receiver antenna (Rx)) (i.e., far field with respect to the subarray as the subarray has a smaller dimension then the full array). Reflected waves may be considered as plane waves for subarray 404 as shown in FIG. 4.

As discussed above, radar 104 may be configured to utilize MIMO techniques, for example, to support a reduced physical array aperture, e.g., an array size, and/or utilize a reduced number of antenna elements. In some embodiments, radar 104 may be a MIMO antenna array. The MIMO radar may include a plurality of Tx antennas (e.g., N elements of a Tx array) and a plurality of Rx antennas (e.g., M elements of a Rx array). The plurality of Tx antennas are configured to transmit a plurality of Tx signals and the plurality of Rx antennas are configured to receive a plurality of Rx signals. For example, radar 104 may be configured to transmit orthogonal signals via the Tx antennas and to process received signals via the Rx antennas.

As described above, utilizing the MIMO techniques of transmission of the orthogonal signals from the Tx array with N elements and processing the received signals in the Rx array with M elements may be equivalent, e.g., under a far field approximation, to a radar utilizing transmission from one antenna and reception with N×M antennas. For example, MIMO radar may be configured to utilize MIMO antenna array as a virtual array having an equivalent array size of N×M. The virtual array may define the location of virtual elements as a convolution of location of physical elements. For example, a virtual channel may be formed as a Kronecker product between a transmit antenna element and a receiver antenna element.

FIG. 5A shows a transmitter array 502 and a receiver array 504 of a MIMO antenna array, according to some embodiments. Transmitter array 502 may include 4 antenna elements (e.g., 502a, 502b, 502c, 502d in FIG. 5A). The antenna elements of transmitter array 502 may be positioned along one direction (e.g., horizontal direction). Receiver array 504 may include 16 antenna elements (numbered 1 to 16 in FIG. 5A). The antenna elements of receiver array 504 may be positioned along one direction. For example, the antenna elements of receiver array 504 may be positioned along the same direction as the elements of the transmitter array 502. In this example, the number of elements or size of the virtual array is 16×4=64 elements.

FIG. 5B illustrates a uniform linear array (ULA) 500 for the MIMO antenna array that comprises transmitter array 502 and receiver array 504. The virtual array is a ULA when the transmitter array 502 and the receiver array are one dimensional and in the same direction (e.g., transmitter array 502 and receiver array 504). ULA comprises 64 elements. For each transmitter of the transmitter array, the corresponding virtual elements are illustrated using the same shading in FIG. 5B. In some embodiments, virtual array may be a two-dimensional array when elements of the transmitter antenna and elements of the receiver antenna are positioned along opposite directions (e.g., Tx in a vertical direction, Rx in a horizontal direction). In order to increase the resolution of the MIMO antenna, the Tx antenna and the Rx antenna may include each a 2D array of antenna elements (e.g., at least two elements in a horizontal directions and two elements in the vertical direction). The corresponding virtual array may be a 2D array in which each virtual element is positioned at a spacing different than the corresponding spacing in the physical array.

AOA processing may be performed on ULA using the FFT process to obtain the spatial spectrum. For a virtual two-dimensional array, the spatial spectrum may be obtained by applying a 2D FFT. In some aspects, the antenna may include a non-uniform array, a scanning radar, or a switching antenna system. For example, in a switching antenna system or switched antenna array, the number of antenna elements may not correspond to the number of RF channels. A desired Tx element and a desired Rx element may be activated while other elements are deactivated. Based on the desired range, antenna elements are identified and activated.

The subarray is selected such as to provide the best quality of signal between the available subarrays. The subset of receiver antennas for near field processing may be identified by selecting elements of the virtual array that are coming from the same Tx elements (e.g., elements associated with Tx 502a, Tx 502b, Tx 502c, or Tx 502d). For example, elements 1 through 16 associated with a first transmitter Tx 502a in FIG. 5B may be used. The group of elements (i.e., elements associated with Tx 502a, Tx 502b, Tx 502c, or Tx 502d) may be selected based on a plurality of factors. The plurality of factors may include transmitter to receiver leakage and calibration quality for each subarray. The leakage may be based on a distance between an Rx element and a Tx element. For example, a Rx element that is farthest from the selected Tx element may be used to reduce the leakage between the two elements. As described further below, spectrum from multiple subarrays may be combined to improve the SNR. The spectrums may be combined non-coherently with low complexity and with some penalty for SNR or coherently using time true propagation model from Tx to targets.

The subset of receiver antennas for near field processing may be identified by testing separation capabilities of radar 104. For example, by testing the separation capabilities of radar 104, the size of the subarray is determined. To test the separation capabilities, the reception of one or more antenna elements may be blocked or attenuated. For example, a radiation absorbent material may be positioned in front of the one or more antenna elements. The performance of the radar is monitored. If the performance of the radar is not changing (or slightly degrade but the performance is still within the system requirement) (i.e., after blocking the one or more antenna elements) then the one or more antenna elements are not included in the subarray.

For a MIMO radar, the subset of receiver antennas may be identified by testing the separation capabilities of the physical receiving array. For example, if the receiving array includes 16 antenna elements, the first 8 elements may be blocked. The formed virtual array would be a subset of the virtual array. The formed virtual array has a size of 8×4=24 elements (assuming the transmitter antenna has 4 antenna elements).

As described previously herein, processor 106 may generate 4D radar information based on radar signals received via Rx antennas. To generate the 4D radar information including azimuth and elevation, at least some of the antenna elements of the RX antenna are positioned along the vertical direction and the horizontal direction (e.g., along a rectangle).

FIG. 6 illustrates AOA spectrums using different AoA processing techniques using ULA 500, according to some embodiments. In the non-limiting illustrative example, a single object at a range of 1 meter. The AOA spectrum is determined using an AoA algorithm.

A first spectrum 602 may be obtained by performing an FFT based AOA beamforming on the full virtual array. The FFT process may use a Chebyshev window (e.g., a 30 point Chebyshev window) in the processing. As discussed above, AOA algorithm using FFT process is designed for a target located in the far field where a single peak is observed with side lobes that are dictated by a windowing function. However, for near field target, the FFT process (which is based on plane wave) fails and thus, a distorted spectrum is produced as shown by first spectrum 602. First spectrum 602 shows a peak 612 and two side lobes 608, 610. However, the two side lobes 608, 610 have a high magnitude. The side lobes may result in false positive (i.e., falsely identifying objects located at ˜7.5 degree and ˜12.5 degree). As described above, there is a nonlinear phase between the elements of the array because the target is in the near field that leads to the distorted spectrum with high magnitude side lobes.

A second spectrum 604 is obtained by processing the radar data using the near field processing based on propagation time modeling from each TX to each RX. The AOA beamforming using near field processing uses matrix multiplication of the received signal by each AOA hypothesis vectors as described previously herein with respect to FIG. 1. Second spectrum 604 shows peak 612 and low side lobes. AOA beamforming using near field processing provides a good performance in sense of resolution and sidelobes. But, the complexity of the near processing is higher than FFT, i.e., O(N²) for matrix multiplication, instead of O(N log N) for FFT. Thus, the near field processing suffers in terms of chip size and power consumption.

A third spectrum 606 may be generated using AOA beamforming using FFT processing for a subarray of the array (e.g., subarray of the virtual MIMO). As discussed above, a smaller array is used in AOA processing for target located in close range of the radar. For the example above, the subarray may include 16 elements. Since the size of the array used in the AOA processing is smaller, the near field effects are reduced (i.e., sphere wave propagation model becomes more linear as shown in FIG. 4).

Third spectrum 606 shows a peak 614. Third spectrum 606 provides low magnitude sidelobes but reduces resolution compared to full array processing (i.e., second spectrum 604 and first spectrum 602). That is, peak 614 is wider than peak 612. However, in many practical scenarios the reduction in AOA resolution is acceptable for objects located in the close ranges. As described above, for close ranges the cross-range resolution in meter can be preserved. This is because the cross-range resolution is proportional to the range and AOA resolution. While for close ranges the range factor is reduced, the AOA beamwidth is increased and thus a fixed cross-range resolution is kept.

In addition to performing AOA processing on a subarray, processor 106 may perform AOA processing on a plurality of subarrays of the radar (e.g., virtual MIMO radar). A respective angular spectrum is generated from each subarray of the plurality of subarrays. Then, the angular spectrums may be combined to improve a signal to noise ratio (SNR) of radar 104. The angular spectrums may be combined non-coherently. Integrating the angular spectrums non-coherently provides the advantage of low computational complexity with some penalty for SNR. Some degradation in SNR is acceptable for close range targets, because even targets with a small radar cross section (RCS) are usually received with high SNR due to the close range.

FIG. 7 is a method 700 for determining a characteristic of a target, according to some embodiments. In an embodiment, method 700 may be implemented in any combination of hardware, software, or firmware. In an example, method 700 may be implemented by a computing system of an automotive vehicle. It is to be appreciated that not all steps may be needed to perform the disclosure provided herein. Further, some of the steps may be performed simultaneously, or in different order than shown in FIG. 7, as will by understood by one of ordinary skill in the art.

Method 700 shall be described with reference to FIG. 1. However, method 700 is not limited to that example embodiment.

At 702, a plurality of receiver antennas receives a plurality of incident signals reflected from the target. For example, the plurality of receiver antennas may correspond to the receiver antenna (Rx) of the MIMO antenna described previously herein.

At 704, processor 106 may analyze the plurality of incident signals (reflected waves) to determine a range of the target. Based on the range processor 106 may determine whether the target is located in the near field or the far field of the radar. The threshold for the far field is determined based on the dimension of the antenna. Processor 106 may compare the threshold for the far field with the determined range to determine whether the target is in the far field or in the near field.

At 706, processor 106 may use AOA algorithm using a subset of receiver antennas when the target is located in the near field of the radar. A subset of receiver antennas is identified from the plurality of receiver antennas. For example, a subarray of receiver antennas is identified. Processor 106 may use AOA algorithm on the full array of receiver antennas when the target is located in the far field of the radar. In some aspects, processor 106 may determine a size of the subset of receiver antennas based on the range. For example, for a target located in the near field the size of subarray may be proportional to the range of the target. The farther the target from the radar system, the larger the size of subarray that may be used.

In different embodiments, the radar system may need to switch between far field processing using the entire array and near field processing using a partial array.

In some embodiments, one or more Tx-Rx channels may be deactivated if a desired target is located in the near field. For example, when a maximum desired range for the radar system is in the near field (e.g., when the vehicle is located in a parking garage), one or more channels or one or more antenna elements may be deactivated. The AOA processing may determine the azimuth and the elevation based on radar signals from the active channels or the active antenna elements.

At 708, processor 106 may perform AOA processing on respective incident signals of the subset of receiver antennas. The AOA processing comprises performing a Fast Fourier Transform (FFT) on radar signals from the subset of receiver antennas, as described above. Processor 106 may determine the azimuth and the elevation based on the AOA processing.

As mentioned above, method 700 in FIG. 7 may be implemented on a computing system. An example computing system is illustrated in FIG. 7.

Reference is made to FIG. 8 which schematically illustrates a product of manufacture 800, in accordance with some demonstrative aspects. Product 800 may include one or more tangible computer-readable (“machine-readable”) non-transitory storage media 802, which may include computer-executable instructions, e.g., implemented by logic 804, operable to, when executed by at least one computer processor, enable the at least one computer processor to implement one or more operations and/or functionalities described with reference to any of the FIGS. 1-7, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 800 and/or machine-readable storage media 802 may include one or more types of computer-readable storage media capable of storing data, including volatile memory, non-volatile memory, removable or non-removable memory, erasable or non-erasable memory, writeable or re-writeable memory, and the like. For example, machine-readable storage media 802 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 804 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 804 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

Based on the teachings contained in this disclosure, it will be apparent to those skilled in the relevant art(s) how to make and use embodiments of this disclosure using data processing devices, computer systems and/or computer architectures other than that shown in FIG. 8. In particular, embodiments may operate with software, hardware, and/or operating system implementations other than those described herein.

Although several embodiments have been described, one of ordinary skill in the art will appreciate that various modifications and changes can be made without departing from the scope of the embodiments detailed herein. Accordingly, the specification and figures are to be regarded in an illustrative rather than a restrictive sense, and all such modifications are intended to be included within the scope of the present teachings. The benefits, advantages, solutions to problems, and any element(s) that may cause any benefit, advantage, or solution to occur or become more pronounced are not to be construed as a critical, required, or essential features or elements of any or all the claims. The invention(s) are defined solely by the appended claims including any amendments made during the pendency of this application and all equivalents of those claims as issued.

Identifiers, such as “(a),” “(b),” “(i),” “(ii),” etc., are sometimes used for different elements or steps. These identifiers are used for clarity and do not necessarily designate an order for the elements or steps.

Moreover, in this document, relational terms such as first and second, and the like may be used solely to distinguish one entity or action from another entity or action without necessarily requiring or implying any actual such relationship or order between such entities or actions. The terms “comprises”, “comprising”, “has”, “having”, “includes”, “including”, “contains”, “containing” or any other variation thereof, are intended to cover a non-exclusive inclusion, such that a process, method, article, or apparatus that comprises, has, includes, or contains a list of elements, does not include only those elements but may include other elements not expressly listed or inherent to such process, method, article, or apparatus. An element preceded by “comprises . . . a”, “has . . . a”, ‘includes . . . a”, “contains . . . a” does not, without additional constraints, preclude the existence of additional identical elements in the process, method, article, and/or apparatus that comprises, has, includes, and/or contains the element. The terms “a” and “an” are defined as one or more unless explicitly stated otherwise herein. The terms “approximately”, “about” or any other version thereof, are defined as being close to as understood by one of ordinary skill in the art. A device or structure that is “configured” in a certain way is configured in at least that way, but may also be configured in ways that are not listed. For the indication of elements, a singular or plural forms can be used, but it does not limit the scope of the disclosure and the same teaching can apply to multiple objects, even if in the current application an object is referred to in its singular form.

The embodiments detailed herein are provided to allow the reader to quickly ascertain the nature of the technical disclosure. It is submitted with the understanding that it will not be used to interpret or limit the scope or meaning of the claims. In addition, in the foregoing Detailed Description, it is demonstrated that multiple features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment in at least some instances. Thus, the following claims are hereby incorporated into the Detailed Description, with each claim standing on its own as separately claimed subject matter.

What is claimed is:

1. A method for determining an angle of arrival of a target, comprising:
receiving, at a plurality of receiver antennas, a plurality of incident signals reflected from the target;
identifying, by a processor, a subset of receiver antennas from the plurality of receiver antennas when the target is in a near field of the plurality of receiver antennas; and
performing, by the processor, angle of arrival (AOA) processing on respective incident signals of the subset of receiver antennas to determine the angle of arrival.

2. The method of claim 1, further comprising:
determining an elevation and an azimuth angle to the target based on the angle of arrival.

3. The method of claim 1, wherein preforming the AOA processing comprises determining an azimuth or elevation spectrum describing a power of the respective incident signals with respect to the angle of arrival.

4. The method of claim 3, further comprising:
integrating respective azimuth or elevation spectra from a plurality of subsets of receiver antennas.

5. The method of claim 1, wherein the plurality of receiver antennas are part of a switched antenna array; and the method further comprising:
activating the subset of receiver antennas.

6. The method of claim 4, wherein the respective azimuth or elevation spectra are integrated incoherently.

7. The method of claim 1, further comprising:
providing a first array of receiver antennas in a first dimension;
providing a second array of receiver antennas in a second dimension different that the first dimension; and
identifying a first subset of receiver antennas from the first array and from the second array.

8. The method of claim 1, wherein the plurality of receiver antennas are a part of a multiple input multiple output (MIMO) radar and the subset correspond to a portion of a virtual array formed by the MIMO radar.

9. The method of claim 8, wherein the virtual array is a two dimensional (2D) array; and wherein the AOA processing comprises performing a 2D FFT.

10. The method of claim 1, further comprising:
transmitting a beam of electromagnetic energy via a plurality of transmitter antennas, wherein the plurality of transmitter antennas and the plurality of receiver antennas are part of a radar.

11. The method of claim 10, further comprising:
determining a range of the target based on a received incident signal from the received plurality of incident signals; and
determining whether the target is in a near field or far field of the radar based on the range.

12. The method of claim 11, further comprising:
determining the angle of arrival using the plurality of incident signals when the target is in the far field of the radar.

13. The method of claim 1, wherein the plurality of receiver antennas are comprised in a vehicle and the method further comprising:
controlling a behavior of the vehicle based on the angle of arrival.

14. The method of claim 1, wherein identifying a subset of receiver antennas comprises:
determining a size of an aperture of the receiver antennas by testing a separation capability of the receiver antennas.

15. A sensor system comprising:
a plurality of receiver antennas configured to receive a plurality of incident signals reflected from a target; and
a processor coupled to the plurality of receiver antennas, wherein the processor is configured to:
identify a subset of receiver antennas from the plurality of receiver antennas when the target is in a near field of the plurality of receiver antennas; and
perform angle of arrival (AOA) processing on respective incident signals of the subset of receiver antennas, wherein the AOA processing comprises determining a characteristic of the target based on the AOA processing.

16. The sensor system of claim 15, wherein the processor is further configured to:
determine an elevation and an azimuth angle to the target based on the angle of arrival.

17. The sensor system of claim 15, wherein the processor is further configured to:
determine an azimuth or elevation spectrum describing a power of the respective incident signals with respect to the angle of arrival.

18. The sensor system of claim 15, further comprising:
a plurality of transmitter antennas configured to transmit a beam of electromagnetic energy, wherein the plurality of transmitter antennas and the plurality of receiver antennas forms a virtual array of a multiple input multiple output (MIMO) radar.

19. The sensor system of claim 15, further comprising:
determine a range of the target;
determine whether the target is in the near field of the plurality of receiver antennas based on the range; and
determine the angle of arrival using the plurality of incident signals when the target is in the far field of the radar.

20. A non-transitory computer readable medium including instructions for determining an angle of arrival of a target that causes a computing system to perform operations comprising:
receiving signal data corresponding to a plurality of incident signal reflected from the target and received at a plurality of receiver antennas;
determining a range of the target;
identifying a subset of receiver antennas from the plurality of receiver antennas based on the range; and
performing angle of arrival (AOA) processing on respective data of the subset of receiver antennas to determine the angle of arrival.

21. A method for determining an angle of arrival of a target, comprising:
determining, by a processor, a desired maximum range;
activating, by the processor, a subset of antenna elements from a plurality of antenna elements based on the desired maximum range;
receiving, at a plurality of receiver antennas from the plurality of antenna elements, a plurality of incident signals reflected from the target;
performing, by the processor, angle of arrival (AOA) processing on respective incident signals of the subset of receiver antennas to determine the angle of arrival.

22. The method of claim 21, further comprising:
determining an elevation and an azimuth angle to the target and a Doppler velocity based on the AOA processing.
